(19) United States
(12) Patent Application Publication
(10) Pub. No.: US 2025/0336317 A1
(43) Pub. Date: Oct. 30, 2025

(54) CHANGEABLE FRAME

(71) Applicant: Rima Häring, Stuttgart (DE)

(72) Inventor: Rima Häring, Stuttgart (DE)

(21) Appl. No.: 18/281,748

(22) PCT Filed: Mar. 7, 2022
(86) PCT No.: PCT/DE2022/000024

§ 371 Date: Aug. 12, 2024

(30) Foreign Application Priority Data
Mar. 5, 2021 (DE) 102021001186.4
Oct. 14, 2021 (DE) 102021005132.7
Nov. 12, 2021 (DE) 102021005629.9

(51) Int. Cl. G09F 13/04; G09F 19/02

(52) U.S. Cl. CPC G09F 13/0481; G09F 13/0413; G09F 13/0458; G09F 19/02

(57) ABSTRACT

The invention relates to an illuminated cylindrical, elliptical, or prismatic interchangeable frame, consisting of an outer cylinder (1), a gap (13), an image (6), and an inner cylinder (5). A homogeneous illumination is achieved through the use of an inner cylinder (5). The illumination is provided by LEDs from a vertical central light source, such as a lighting element (4) or through edge illumination. The power supply is provided by cables, an electrochemical primary cell, an electrochemical secondary cell, a fuel cell, an arrangement of supercapacitors, or a combination of the aforementioned power sources.

### STATE OF THE ART

The invention relates to an illuminated cylindrical or prismatic interchangeable frame. Advertising columns have long been known as advertising media and are available in many different designs. They are up to several meters high and have a corresponding diameter. The much smaller light columns or floor lamps are also known as light sources for private areas and as advertising media in a wide variety of designs and with or without printed, glued or stretched motifs.

What was sought were light columns with a homogeneous internal light source with the possibility of changing the motifs easily, non-destructively and without removing any adhesive, whereby the motifs are on translucent foils, translucent canvas, translucent paper and other translucent materials at a height of up to two meters. The motifs are prints, pictures, photos or works of art that are intended to remain permanently dimensionally stable and protected under changing environmental conditions such as temperature and humidity.

Changing the motifs should be easy and possible without the need for a specialist. The image should be protected from contact and vandalism. This is especially important for works of art. The light irradiation on the motifs, prints, pictures, photos or works of art should also be as homogeneous as possible. The column should make it possible to take up a single image without subdivision. In one execution type, the only optical interruption is where the 2 ends of the 360° arranged image meet.

In contrast, an advertising column, due to its size, consists of individual images or optical segments with visible image interruptions. In addition, a simple exchange of the motifs is not possible due to the size alone.

Unless otherwise stated, the term “image” is used below as a synonym for a motif-bearing translucent material.

All light columns, illuminated columns or advertising columns found on the market, even high-priced ones, in the preferred height of 60 cm to 170 cm did not meet the above-mentioned requirements. This gives rise to the task of protecting the image itself, making it easy to replace without causing damage and illuminating the image evenly.

A further task arises from the size of the image-holding column.

Depending on the material, pictures with a height of approx. 20 cm or more are not always stable when freestanding.

This means that without a duct, support or mechanical fastening, the image will create waves, which will disturb the aesthetic impression for the viewer.

It is preferred to use a single translucent support for the image.

The picture should be placed without mechanical stress from clips and without gluing. However, it should also be possible to place several motive-bearing translucent materials or images one after the other, where “one after the other” means from the viewer's perspective. Several images then create an overall picture.

If the motif-bearing translucent material e.g. a printed translucent photo, is not fixed, it will give in. Depending on the changing room conditions and the respective material, this happens after just a few hours, days, weeks or months. The photo is warping.

A translucent canvas with a motif is not free-standing and collapses or becomes severely deformed.

If the image is thick enough to be stable when standing freely, it is usually no longer translucent.

### TASK AND DESCRIPTION

The object of the invention is to provide a cylindrical, elliptical or prismatic, internally illuminated interchangeable frame with the aforementioned properties.

This interchangeable frame should have a length that is a multiple of the diameter and should uniformly illuminate a motif-bearing translucent material from the inside with one or more light sources, directly or indirectly, whereby the motif-bearing translucent material can be changed easily and without damage.

Furthermore, it is an object of the invention to arrange the motif-bearing translucent material in such a way that it is protected from external influences such as.

E.g. temperature, humidity, touch, Protected against vandalism, dust or dirt without affecting the presentation.

In particular, protection against mechanical damage should be guaranteed, as with a rectangular glass picture frame.

Uniform irradiation means that no shadows or point-like or line-like light sources are visible to the observer from the outside.

In addition to use by private individuals in the home, the area of application of such a cylindrical, elliptical or prismatic interchangeable frame is in the commercial sector for the presentation of prints, photographs, paintings and works of art and in galleries and museums.

Other fields of application include doctor's offices, clinics, law firms, hotels, cafes, representative reception rooms, exhibitions, trade fairs and in advertising.

The invention is described below and explained in more detail using examples shown in the drawings.

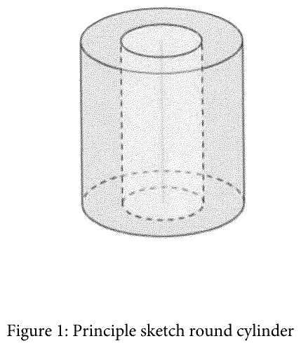

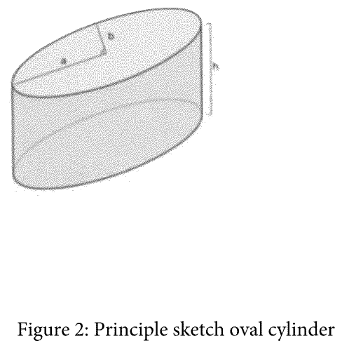

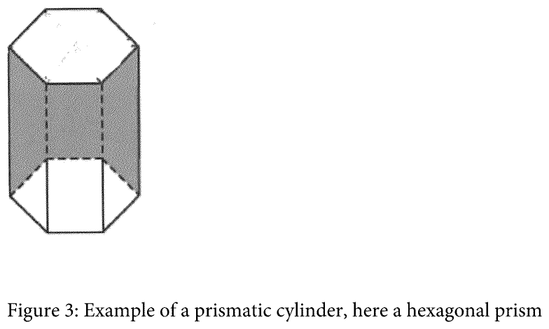

The object is achieved by providing an illuminated cylindrical, elliptical or prismatic interchangeable frame for motif-bearing translucent materials (6) comprising an elongated housing (1) with a round (FIG. 1), elliptical (FIG. 2) or prismatic (FIG. 3) cross-section and having translucent walls, which is closed at one end by a base plate (2a) or a base (2b), has a lid (3) at its other end and one or more electrical light sources (4) within the housing, wherein between the light source(s) and the motif-bearing translucent material in cross-section view there is another round, elliptical or prismatic hollow body without a cover or base.

The image is located behind a rigid, transparent, round, circular, elliptical or prismatic wall and is therefore sufficiently protected against mechanical damage from outside, touch, vandalism, dust or dirt.

For the sake of simplicity, the terms inner hollow body (5) and outer hollow body (1) are used hereafter, where hollow body in this application stands for elliptical, circular or prismatic cylinder.

The inner hollow body (5), i.e. the inner elliptical, circular or prismatic cylinder, consists of a translucent material, preferably glass or plastic, and serves to support the image (6) and as a diffuser. A gap (13) or a space is created between the outer transparent hollow body (1) and the inner hollow body (5), which serves to hold the image. In one execution type, the inner hollow body consists of pearled and/or satin-finished acrylic glass.

In another execution type, the inner hollow body is made of an evenly light scattering plastic. As such a plastic, a composite is suitable, that is made of one or more transparent plastics and light reflecting or light refracting powdery admixtures. Composites of this kind are known. In one execution type the inner hollow body is made of pearled and/or satined acrylic glass or Polymethyl methacrylate (PMMA).

The image carrier materials, i.e. the translucent materials carrying the motif, are made of a flexible flat material, such as E.g. paper, parchment paper, photo paper, plastic, perforated metal foil or fabric made of natural and/or synthetic fibres (canvas). Plastic films are preferred as image carrier material. Suitable printable plastic films are, for example, made of PET-polyethylene terephthalate, polypropylene or polyethylene or composite materials containing these substances. The film may be coated for printing. The printable plastic films are crystal clear, white-matt translucent or matt-translucent. Corresponding films are available on the market in many variations. All materials that are suitable as diffuser materials and appear matte or white-matte are preferred as translucent motif-bearing materials. In one execution type, several images are placed one after the other from the viewer's perspective; in this case, it is preferred that at least one of the images is applied to a transparent film. The motif-bearing translucent materials (images) are inserted, placed or arranged between the inner and outer hollow body.

The motif-bearing translucent materials have a preferred thickness of 50 to 500 μm, with a particularly preferred range of 75 to 250 μm, and a most preferred range of 95 to 175 μm. The canvases used are characterized by the unprinted or unpainted surface weights. Canvases with a surface weight of 200 to 500 grams per square meter are suitable. The range from 280 to 380 grams per square meter is particularly preferred.

The diameter of the inner hollow body is limited by the diameter of the outer hollow body minus the wall thickness and the desired gap width (13) for inserting the image. The preferred range of the diameter of the inner hollow body is 10 to 100 cm, particularly preferred is the range from 20 to 80 cm. The height of the inner and outer hollow bodies ranges from 10 cm to 250 cm, with a preferred range of 20 cm to 220 cm, and a particularly preferred range of 30 cm to 190 cm. The gap between the inner and outer hollow body ranges from 2 mm to 400 mm, preferably 2 mm to 200 mm, and most preferably 2 mm to 8 mm. In an execution type with gap widths of up to 400 mm, several motif-bearing translucent images are placed one behind the other between the inner and outer hollow body.

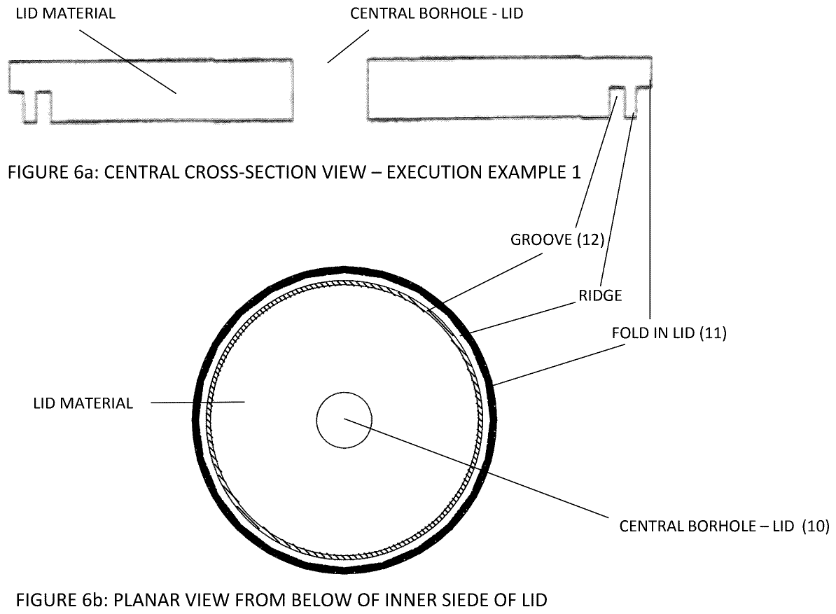

In one execution type, there are guide grooves in the base and/or the lid for fixating the picture or pictures (FIG. 6c). The grooves are preferably circumferential and have a preferred depth of 3 mm to 80 mm and a preferred width of 51 μm to 5 mm. The wall thickness of the inner and outer hollow body results from the requirement for static stability and is preferably 2 mm to 20 mm. The outer diameter of the outer hollow body ranges from 11.4 cm to 105 cm. In one execution type, a self-supporting film is used instead of the inner hollow body, functioning as a diffusor. The self-supporting film's wall thickness is preferably in the range of 100 μm to 2000 μm. In one execution type, the gap between the inner and outer hollow body is up to 40 cm. The motif-bearing translucent material is held in place by a groove in the base and/or lid. The specifications for wall thickness, height, diameter and gap width are not limited. They result from the need for stability, the easy exchange of motive-bearing materials and the required light transmittance. In this way, several hollow bodies with a wall thickness of less than 1 mm can be placed one behind the other or inside each other to achieve sufficient stability. However, these designs are less stable and more expensive.

As already described, in one execution type several motif-bearing translucent images are used, i.e. placed one after the other. For the viewer, a single image emerges. By simply adding or removing images, the overall image that the viewer sees can be quickly changed. This execution type is preferably used for artistic presentations and in educational settings, such as illustrating processes or procedures.

Axially arranged light-emitting diodes (LEDs) on a printed circuit board or circuit board are preferably used as the light source (4). These rod-shaped LED lamps are known and available on the market as LED tubes. They have high energy efficiency. In one execution type, LED tubes with a power supply on one side are used, with the other end being replaced by an insulated short-circuit bridge. This is an example of a direct light source or direct illumination for lighting the image.

It is possible to connect the LEDs to a control device, whereby they can be controlled in such a way that their luminosity and/or colour can be changed as a whole, in groups or individually. This enables particularly interesting lighting effects, which are advantageous in the advertising industry and in retail spaces. The preferred option is to use white light with a control for the light intensity, i.e. for dimming.

In execution type 1, the light source (4) is equipped with a dimming device. This is located on the supply cable between the power connector plug and the power supply input on the device. In addition or alone, the control can also be carried out with a remote control, whereby the receiving unit for the control is connected to the light source and/or power supply. It is preferred that the outer hollow body is made of transparent acrylic glass (PMMA), which is a lightweight material, easy to process and has good optical quality.

In addition to its supporting function for the image, the further task of the inner hollow body is to serve as a Lambertian radiator for the image. The Lambertian radiator is a physical ideal. In the present invention, it is sufficient if, for the human observer, no point or rod-shaped light source or shadow casting is visible. Regardless of the viewing direction, each point is perceived as equally bright. It is advantageous for the inner hollow body to have a white, diffusely reflective surface, preferably satin-finished acrylic glass and/or pearled acrylic glass.

There is a gap (13) between the inner and outer hollow body. The image is placed into this gap and can be removed and replaced without damage. The inner hollow body limits a “waving” of the image. Such a “waving” can be caused, for example, by the image's own weight or changing environmental conditions such as humidity and temperature over the course of the day or the seasons.

Preferably, a translucent, heat-resistant plastic film is used as the image carrier. In this application, a film is considered heat-resistant if it can withstand temperatures up to 70° C.

### EXAMPLES

The lid holds the inner hollow body in position between the light source and the outer hollow body. The lid protects the interior of the entire body from external influences from above. The lid has a circumferential fold. With this fold, the lid rests on the outer hollow body.

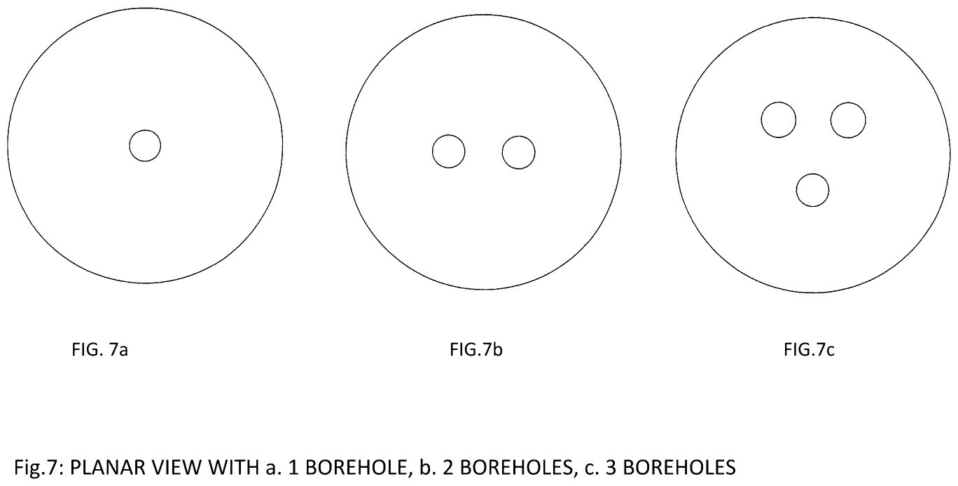

The lid preferably has one or more holes (FIG. 7). These holes serve for ventilation and as a handle hole. If there is one hole, it is centrally located. Preferred diameters of the hole are between 2 and 5 centimetres.

In further examples, the lid has different mechanisms or devices for easy removal. These include, for example, small opposing holes to accommodate a tool for rotational movement or mechanical lifting. In one example, the lid has a thread and the corresponding outer cylinder contains the corresponding opposite thread. The thread can be an external or internal thread, e.g. outer cylinder with an external thread and a corresponding lid with an internal thread.

The lid can additionally contain a lock for protection against unauthorized opening. The locking mechanism connects it to the outer hollow body.

Materials that can be used for the lid are wood, clay, porcelain, metal, plastic, glass or a combination of these materials. This list is not limiting. Any material that fulfills the function of the lid is suitable.

Depending on the example, the inner hollow body is fixed in the base plate or the pedestal and/or the lid. The fixation is achieved by a groove or fold in the base and/or lid, which preferably fits precisely. The fixation ensures that the inner hollow body is held in the desired position. Preferably, the inner hollow body is fixated via the lid. The fixation via the lid is sufficient. For each inner hollow body, there is a matching groove or fold in the lid. This has the advantage that, depending on requirements (customer request), different inner hollow bodies in size and/or material can be used, and only the lid or the groove in the lid needs to vary depending on the size of the inner hollow body. This allows greater flexibility in selecting inner hollow bodies. Fixating the inner hollow body via the lid is usually more cost-effective than modifying the base plate for fixating the inner hollow body.

In one example, the inner hollow body consists of a light-refracting ree-standing film that acts as a diffuser.

In one example, there is a seal between the lid and the outer hollow body for outdoor use of the entire body. The bond between the lid and the outer hollow body then meets the requirements for rain proofness, e.g. an IP67 certification. In this example, the lid does not have a continuous hole.

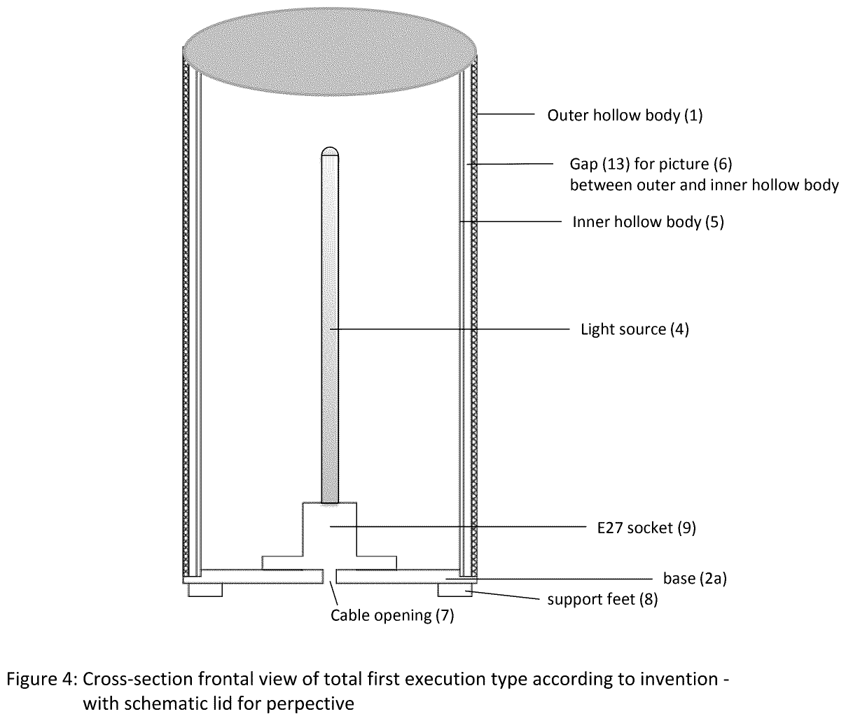

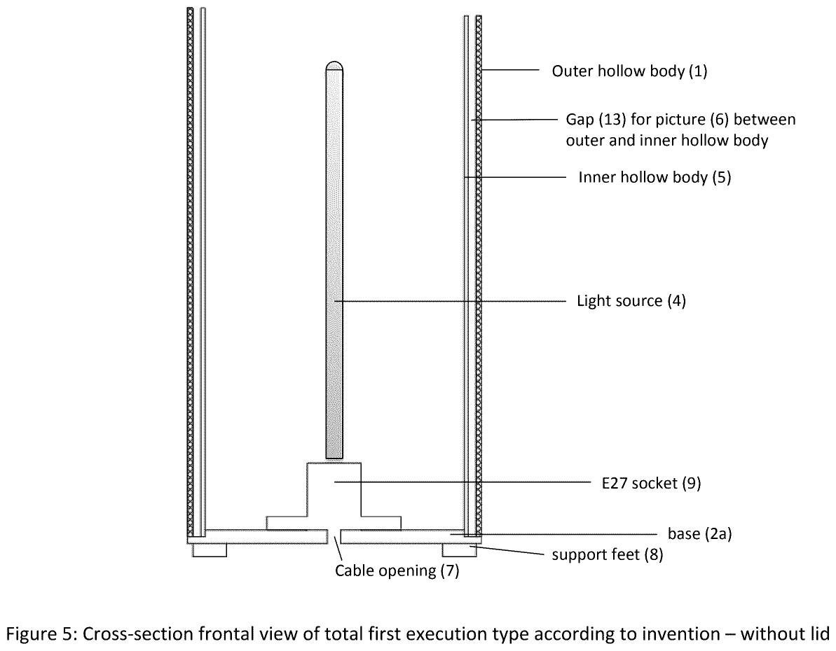

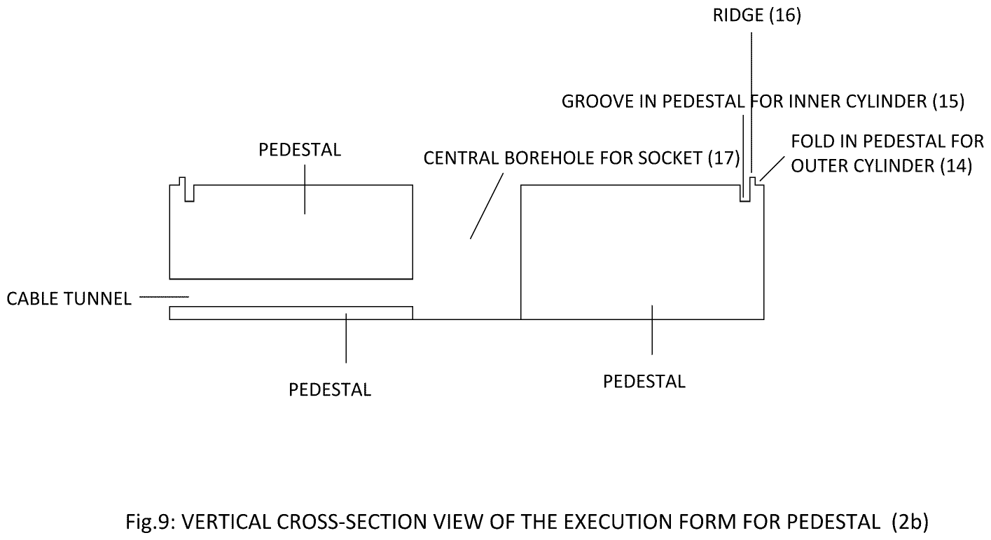

In one example, the base plate (2a in FIG. 4 and FIG. 5) or the pedestal (2b/FIG. 9) has a hole (7) for the passage of the power cable.

One or more sockets (9) for accommodating the light sources are mounted on the inside of the base plate (2a) or pedestal (2b).

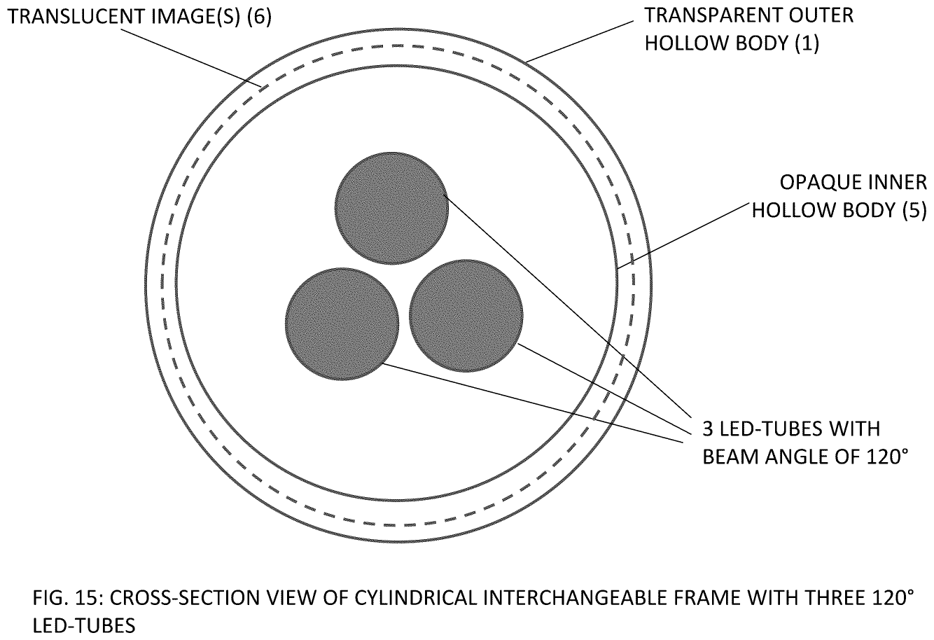

In one example, three LED tubes with a light beam angle of at least 120° are arranged in a triangular configuration to achieve a total beam angle of 360° (FIG. 15). Dimmable LED tubes are available in the preferred lengths with an beam angle of 120°, while dimmable LED tubes with an beam angle of 360° are not available in the preferred lengths, or cost several times more than the three 120° LED tubes.

In a preferred example, individual LEDs are mounted lengthwise on a rod, preferably rectangular. The preferred execution was to glue the LED strips onto a rectangular, hollow, elongated aluminium profile. This hollow rectangular aluminium rod covered with LEDs was mounted centrally in the inner cylinder. The result is an absolutely uniform illumination of the image. The viewer cannot see any differences in the illumination across the surface of the image.

In one example, #support feet (FIG. 4 (8)) or castors are attached under the base plate or pedestal.

In one example, the base plate or pedestal is mechanically or electrically rotatable.

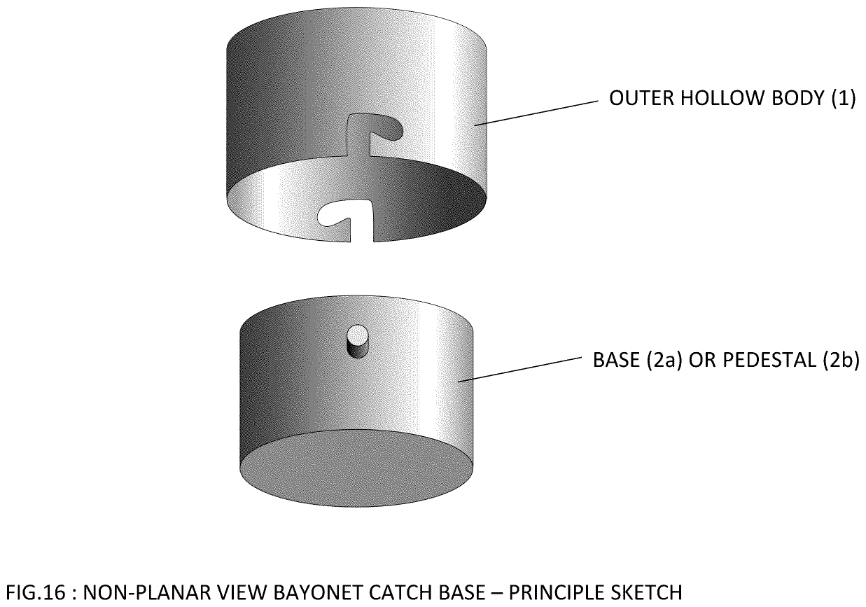

The outer hollow body is connected to the base plate or pedestal or fixated to the base plate or pedestal. The connection is made either by gluing (see example 1, base plate 2a) or by a quickly producible and detachable mechanical connection of the two parts along their longitudinal axis. This quick and detachable mechanical connection is achieved, for example, via screws, a fold, a groove or via a bayonet lock or bayonet holder (FIG. 16). Depending on the requirements for the required stability and the assembly and disassembly speed, the connection via screws, fold, groove or bayonet lock or bayonet holder is sufficient. Adhesive bonding or any other material connection that cannot be easily separated will not be used then. If the connection is made via a fold or groove, then the outer hollow body is placed on the base and held in place by a fold (see example 2, pedestal 2b).

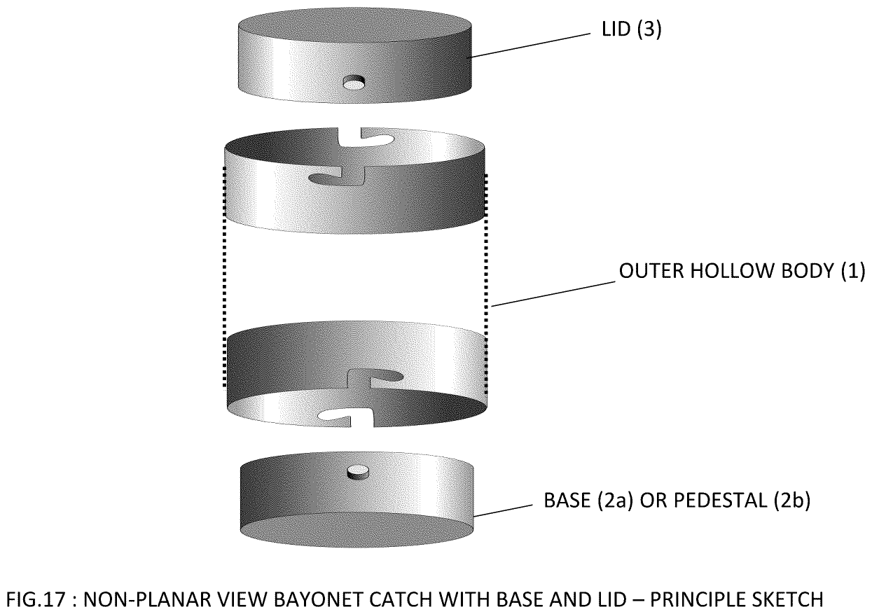

The inner and outer hollow bodies can be independently connected to the base and the lid via a bayonet lock or a bayonet holder (FIG. 17). The individual joining methods can be combined.

Usable materials for the base plate or pedestal can be wood, plaster, clay, stone, marble, porcelain, concrete, metal, plastic, glass or a combination of these materials. This list is not limiting. Any material that fulfils the function of the base plate or pedestal is suitable.

All LED tubes that allow power supply via one side, i.e. are connected on one side, are preferred as light sources. The power supply then comes either from the bottom or from the lid.

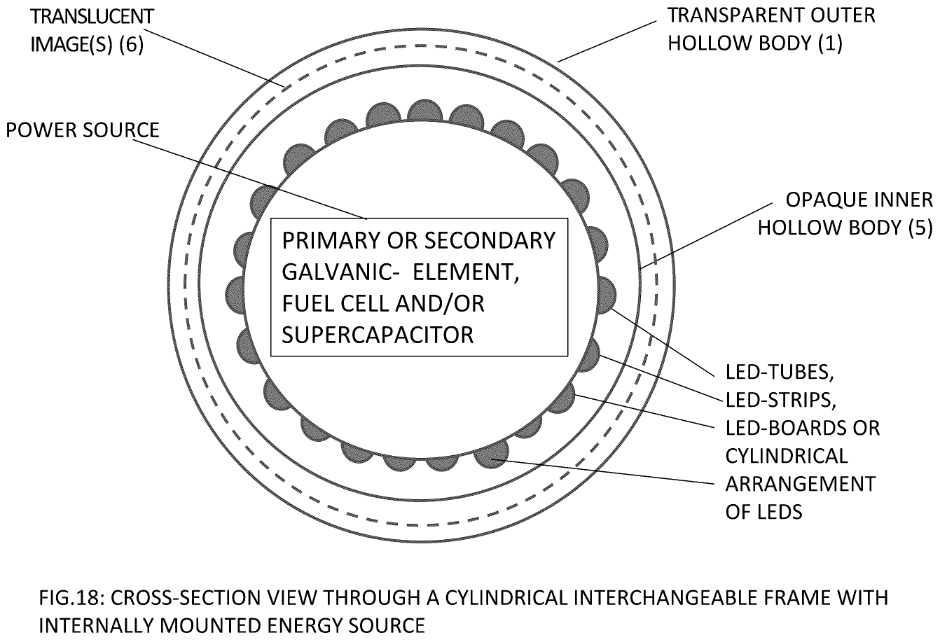

In one example, the power supply for the electrical consumers is provided by a built-in power source. The power source is then located in the lid, in the pedestal or centrally positioned. In the central arrangement, the power source is circularly surrounded by the light source (FIG. 18). The power source can be an electrochemical primary cell, an electrochemical secondary cell, a fuel cell, an arrangement of supercapacitors or a combination of the aforementioned power sources.

The execution of the central axial arrangement has the advantage that a much larger amount of energy can be stored compared to the storage in the base or in the lid. In this arrangement, 100× times or more energy is available. Particularly preferred is a hybrid system of a fuel cell and battery, wherein the fuel cell is operated with C1 energy storage media such as methanol, formaldehyde, formic acid, dimethyl ether, dimethoxymethane and oligomers polymers and thereof. The fuel cell recharges the battery with constant low power, acting as a range extender. For example, the achieved energy densities of such a fuel cell-battery hybrid system are sufficient for 2000 operating hours with a height of 150 cm and a diameter of 30 cm of the battery body. In this example, the light source has a power consumption of 15 to 20 watts. In a high-quality type of execution, the inner surface of the inner hollow body is densely covered with individual LED elements.

In a further execution, the power supply for the electrical consumers is arranged centrally, preferably axially in the inner hollow body, with the light source surrounding the power source in its axial orientation (FIG. 18).

### Using Edge Illumination With LEDs as Light Source

In a further special type of execution, the inner hollow body has a rasterized surface made of polyacrylic glass (PMMA). The light irradiation is created via LEDs on the edges of the inner hollow body, the adjacent base/pedestal, and/or via the adjacent lid. Within the bulk material of the inner hollow body, total internal reflection of the light occurs. The hollow body functions as a light conductor. The light only emerges at the rasterized surface.

In a further type of execution of the indirect light source, the inner hollow body consists of a transparent plastic, preferably PMMA, with embedded light-scattering particles. The feed-in of light is achieved via LEDs at the edges of the inner hollow body, the adjacent base/pedestal, and/or via the adjacent lid.

In the two latter executions of indirect lighting via edge illumination, the inner hollow body is additionally provided with a white reflective film or coating on the side facing away from the motif.

This results in a very even illumination of the image. These are two examples for an indirect light source for illuminating the motif-bearing translucent material.

The feed-in of light via edge illumination is particularly advantageous because the interior space of the cylinder is now empty and allows the use of the cylinder's interior space. In one execution, power sources, sensors, and technical devices for the purpose and operation of the light source and e.g. the rotating body are housed in the interior space. These include batteries, fuel cells, fuel tanks for the fuel cell, electronics or rotary motors.

In a further execution, the interior space is now used for completely different purposes. In one of these executions, the interior space is used to accommodate an air filtering device. This air filter unit features a HEPA filter, preferably of class H14, a catalytic filter for removing air pollutants such as formaldehyde and carbon monoxide, a humidification and/or dehumidification unit, sensors for detecting air quality, fans for air intake and output, and/or a device for removing carbon dioxide from the ambient air. If the interior space is used to accommodate an air filter, there are corresponding openings located in the base and in the lid for the uptake of unfiltered air and the release of filtered air. The filter units for HEPA filtration and carbon dioxide filtration are replaced through the upper opening in the lid or made accessible by lifting the outer and inner cylinders. Access via the lid is preferred.

If a carbon dioxide filter is used together with a HEPA filter, then also an additional valve or deflection device for the incoming air is mounted. The deflection device directs the airflow past the HEPA filter directly to the carbon dioxide filter. The advantage is a reduction in pressure loss in air that has already been purified but still contains too much carbon dioxide. The air filter is controlled via automatic or manual control. The individual devices, like the interchangeable frame, can be operated via NFC, WLAN, Bluetooth, or similar well-known devices.

In one execution, the cylindrical interchangeable frame also has externally mounted LEDs to illuminate the room. These LEDs radiate light either directly upwards and/or sideways upwards. The radiating LEDs are preferably shielded in the horizontal direction towards the viewer so that the viewer is not dazzled by the emitting LEDs.

Depending on the execution, the electrical consumers include the light source, the switch, the dimmer, the remote control, the rotation device, the electronics for remote control, and for the combination of the aforementioned power sources. In one execution, the interchangeable frame according to the invention contains proximity sensors and/or smoke detectors.

The following exemplary executions with accompanying figures serve to illustrate the invention. As is evident to those skilled in the art, the examples are illustrative and not limiting.

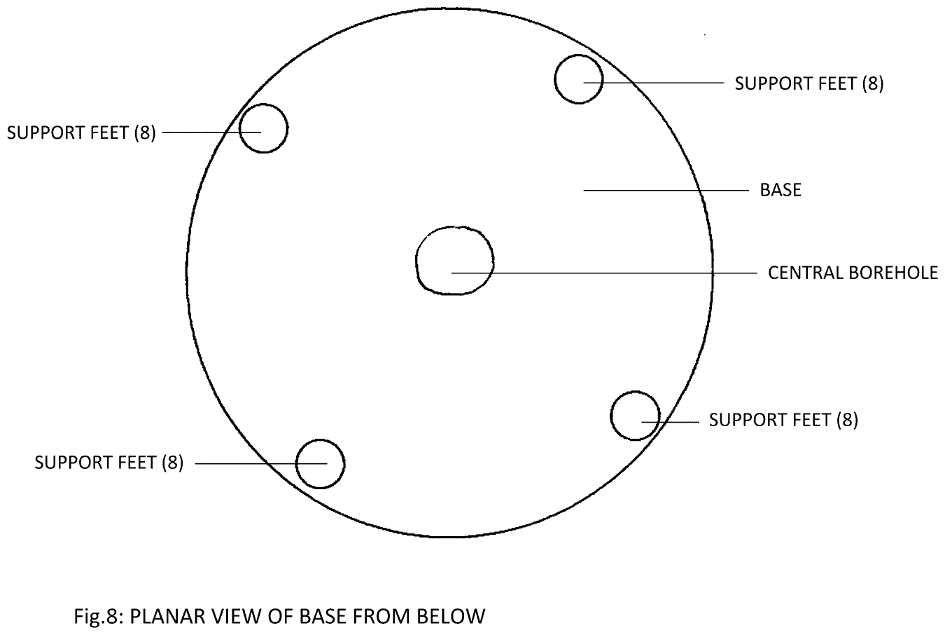

### Example 1 (shown in FIG. 4, FIG. 5, FIG. 6, and FIG. 8)

An outer cylinder (1) made of transparent acrylic glass with an outer diameter of 220 mm, a height of 597 mm, a wall thickness of 4 mm and an inner diameter of 212 mm is glued flush onto a base plate (2a). The base plate (2a) has a thickness of 10 mm, a diameter of 220 mm, a fold of 14 mm width and a height of 5 mm. The base plate (2a) has a central hole (7) for the passage of the power cable.

Four round feet (8) made of Plexiglas are glued under the base plate. Their height is 15 mm with a diameter of 20 mm.

Before gluing the base plate (2a) to the outer cylinder (1), an E27 socket (9) for holding the light source (4) is mounted with two screws on the inside of the base plate on its center.

A square acrylic glass plate (edge length 90 mm) with a thickness of 8 mm is glued under the base plate (2a). The power cable runs through a wave-shaped channel, which was milled in the plate, serving as strain relief.

The power cable is 2 m long and has a 230-volt flat plug, with a dimmer with a rotary switch located approximately 130 cm from the plug.

Due to the fold milled out on the inside of the base plate, a central, circular elevation of 5 mm in height remains on the inside of the base plate, which is precisely enclosed by the inner cylinder (5).

The inner cylinder (5) is made of pearled, satin-finished acrylic glass. This results in high level of light scattering. In this execution, the light transmittance is approximately 83%.

The inner cylinder (5) has an outer diameter of 200 mm, a wall thickness of 3 mm, an inner diameter of 194 mm and a height of 597 mm.

The lid (FIGS. 6a and 6b) has an outer diameter of 220 mm, a thickness of 10 mm, a fold (11) of 5 mm width with a height of 5 mm. At a distance of 9 mm from the outer edge, there is a continuous groove (12) with 5 mm width and 5 mm depth. The lid has a central borehole (FIG. 6b (10)) with a diameter of 26 mm. This borehole serves for ventilation and as a gripping aid for removing the lid. The lid is made of satin-finished acrylic glass.

There is a gap (FIG. 5 (13)) of 6 mm between the inner cylinder (1) and the outer cylinder (5). The image is now placed in this gap. The image is a printed PET film measuring 660×594 mm. The film has a thickness of 190 micrometers. The unprinted film is white matte translucent.

The light source used is a 520 mm long LED tube (FIG. 5 (4)) with an E27 socket (FIG. 5 (9)).

The lid (FIGS. 6a and 6b) has a circumferential fold (11) and a groove (12) for a precise fit of the inner cylinder (5) and rests on the outer cylinder (1).

The following comparison tests were conducted:
a) Illuminated cylinder with inner and outer cylinder with lid and without image: From a distance of 10 cm to ten meters and beyond, the central LED tube is not visible. The inner cylinder as a whole is perceived as the light source.
b) Setup as in a), but with the inner cylinder removed. The LED tube is clearly visible.
c) Illuminated cylinder with inner and outer cylinder with lid and image, with the following motifs tested: a sandy desert with sky, a sunset over the sea, an art print with many different colors, and a high-contrast photo of a wedding couple. The result is that for none of the motifs used, the silhouette of the light tube or differences in illumination in the image, caused by insufficient light diffusion, are noticeable.

The images can be changed quickly and easily.
d) The same images are now used without the inner cylinder as a diffuser. The axial light source is clearly visible in each image. The images are no longer evenly illuminated.

### Example 2 (Shown in FIG. 9)

As in example 1, except that a pedestal is used instead of an glued base plate.

An outer cylinder (1) made of transparent acrylic glass with an outer diameter of 220 mm, a height of 597 mm, a wall thickness of 4 mm and an inner diameter of 212 mm is placed flush on a fold in the pedestal (FIG. 9 (14)). The pedestal (FIG. 9) has a height of 550 mm and a diameter of 220 mm. The pedestal has a fold of 6 mm width (FIG. 9 (14)) on which the outer hollow body is placed. The pedestal also has a ridge of 3 mm width and 3 mm height (FIG. 9 (16)), and a groove of 6 mm width and 13 mm height (FIG. 9 (15)). The inner hollow body is placed in this groove (15).

The pedestal (FIG. 9) has a central borehole (17) for the passage of the power cable and to fixate an E27 socket (9) for holding the light source. The pedestal contains a strain relief for the power cable located in the cable tunnel. The power cable is 2 m long and has a 230-volt plug, with a dimmer with a rotary switch located approximately 130 cm from the plug.

The inner cylinder (5) is made of pearled, satin-finished acrylic glass, resulting in high light scattering. In this execution type, the light transmittance is approximately 83%.

The inner cylinder (5) has an outer diameter of 200 mm, a wall thickness of 3 mm, an inner diameter of 194 mm and a height of 597 mm.

The lid (FIG. 6) has an outer diameter of 220 mm, a thickness of 10 mm, a fold (11) of 5 mm width with a height of 5 mm. At a distance of 9 mm from the outer edge, there is a continuous groove (12) with 5 mm width and 5 mm depth. The lid has a central borehole (FIG. 6b (10)) with a diameter of 26 mm. This borehole serves for ventilation and as a gripping aid for removing the lid. The lid is made of satin-finished acrylic glass.

There is a gap of 3 mm between the inner cylinder (5) and the outer cylinder (1). The image is now placed in this gap. The image is a printed PET film measuring 660×594 mm. The film has a thickness of 190 μm. The film is white matte translucent.

A 520 mm long LED tube with an E27 socket is used as the light source.

The lid (FIGS. 6a and 6b) has a circumferential fold (11) and a groove (12) for a precise fitting of the inner cylinder (5) and rests on the outer cylinder (1).

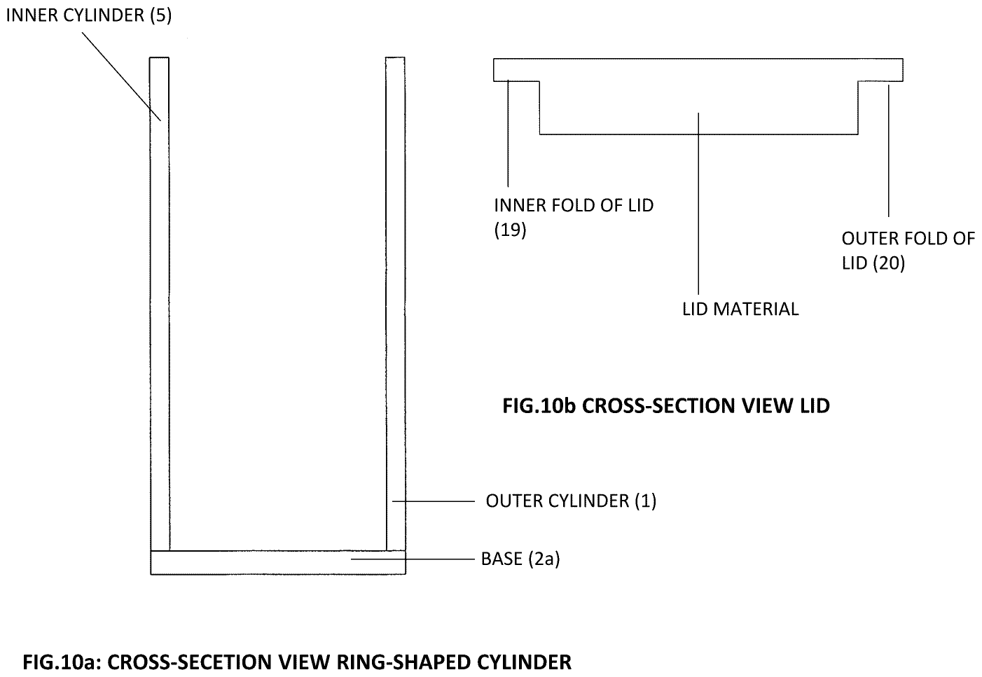

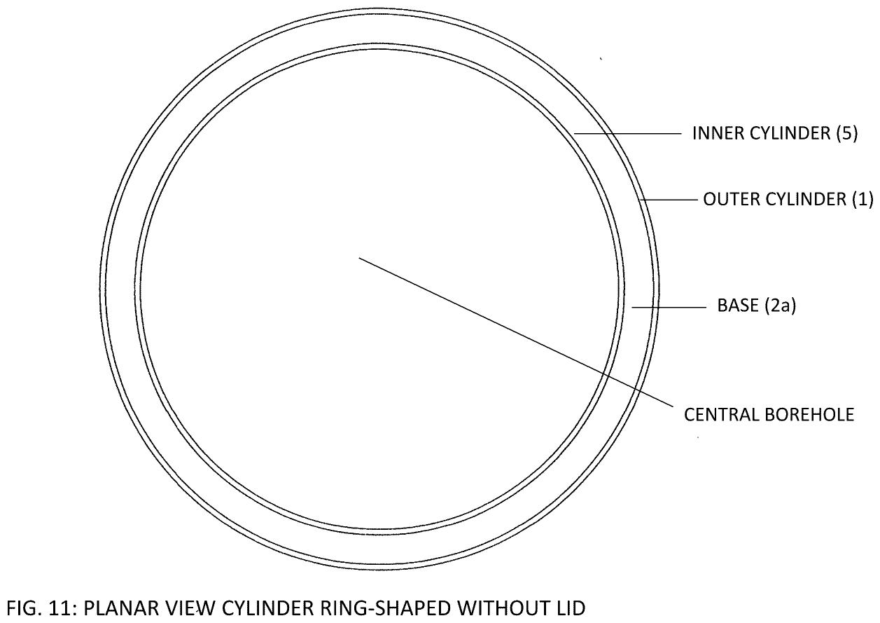

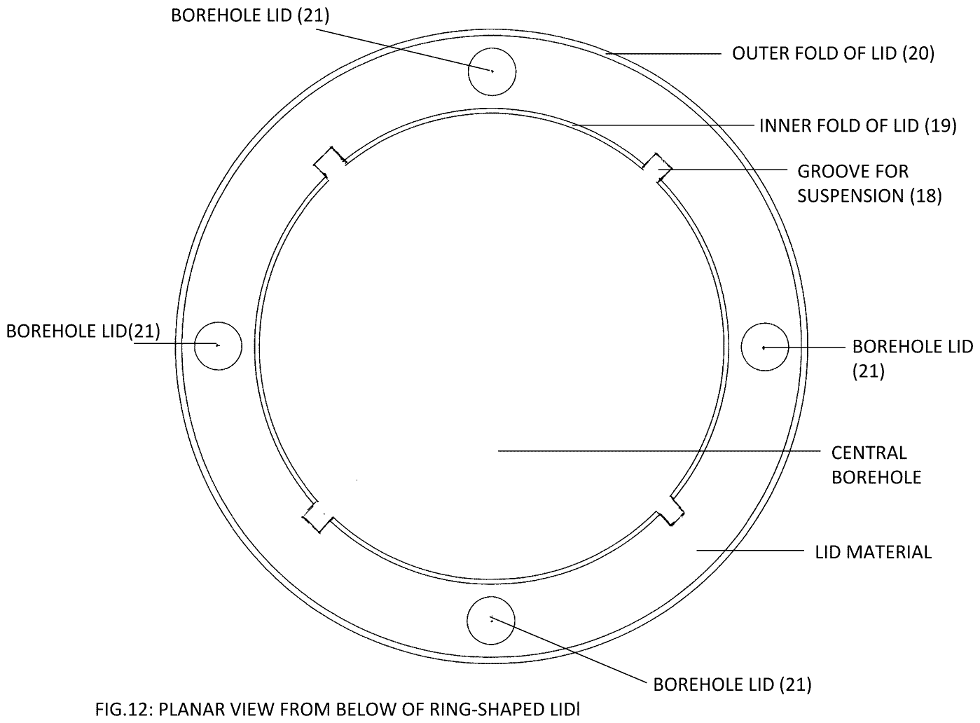

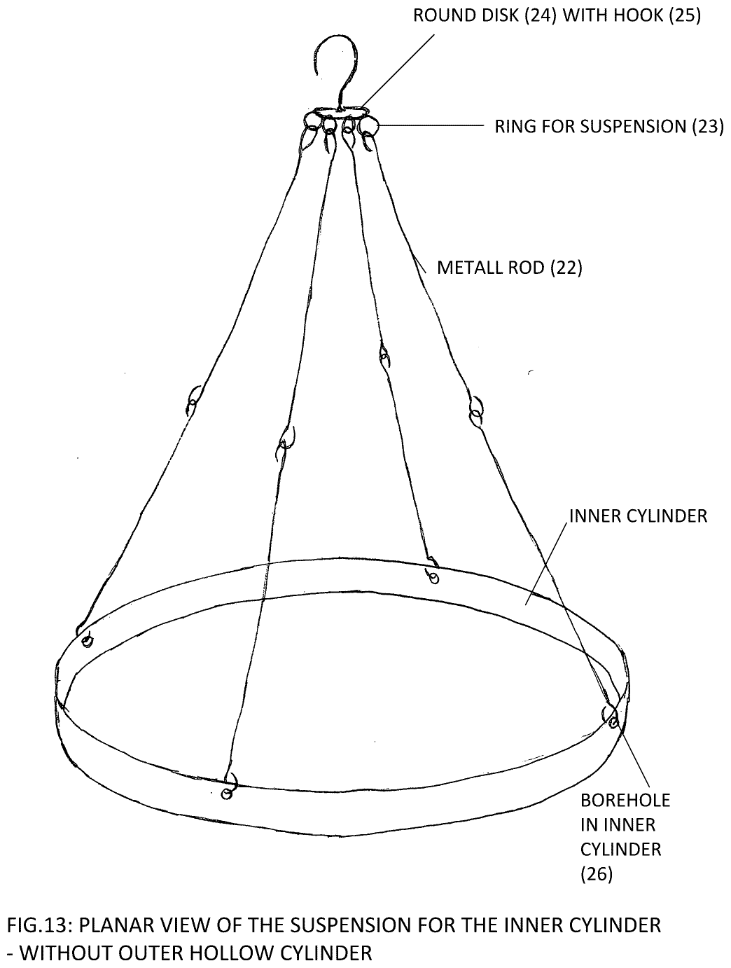

### Example 3 (Shown in FIG. 10, FIG. 11, FIG. 12, FIG. 13)

An outer cylinder (1) made of transparent acrylic glass with an outer diameter of 400 mm, a height of 105 mm, a wall thickness of 4 mm and an inner diameter of 392 mm is glued flush on a base plate (2a). The base plate (2a) has a thickness of 5 mm, a diameter of 400 mm, with a central borehole of 294 mm diameter.

An inner cylinder (5) made of satin-finished acrylic glass with an outer diameter of 300 mm, a height of 105 mm, a wall thickness of 3 mm and an inner diameter of 294 mm is also glued flush on the base plate (2a).

There is a gap of 46 mm between the inner cylinder (5) and the outer cylinder (1). The image is now placed in this gap so that the image rests against the inner wall of the outer cylinder. The image is a printed PET film measuring 123 cm×10.5 cm. The film has a thickness of 190 μm. The film is matt white translucent. The image is fixed by a fold in the lid.

The lid (FIG. 11) has an outer diameter of 400 mm, a thickness of 10 mm, and a central borehole with a diameter of 294 mm, giving the lid the shape of a ring. The lid has a fold of 6 mm width and 7 mm height on the outer edge and a fold of 4 mm width and 7 mm height at the inner edge (FIG. 10b).

The lid rests with the inner flange (19) and the outer flange (20) on the inner and outer cylinders. The lid is made of satin-finished acrylic glass.

The ring-shaped lid has 4 central boreholes (21) with a diameter of 30 mm. The 4 boreholes are the same distance apart, with each pair of two holes directly opposite the other (FIG. 12). These serve for ventilation and as a gripping aid for removing the lid.

This ring-shaped cylinder can be placed standing on a surface or hung up.

The light source of the hanging cylinder hangs from the ceiling by a power cable and is surrounded by the cylinder. For suspension purposes, the cylinder in this execution type has four round boreholes (26) in the inner cylinder. The boreholes are equidistant from each other, with each pair oft wo holes facing each other (FIG. 13). The holes have a diameter of 6 mm and their center is 8 mm from the upper edge of the inner cylinder wall.

In this execution, the suspension (FIG. 13) is achieved with four two-segment metal rods (22), each with a hook at both ends. The metal rods are 20 cm long and can be hung into each other. This allows the lengths of the metal rods to be varied in 20 cm increments. At the top end, the 4 metal rods (22) are hung centrally on rings (23) which are attached to a round plate (24). The round plate (24) has a hook (25) for suspending the entire body from a ceiling-mounted round hook. The round plate (24) has 4 rings (23) into which the 4 metal rods (22) are hooked (FIG. 13).

The lid (FIG. 12) has 4 equally spaced grooves (18) on the inner edge, each 5 mm deep and 5 mm wide. These allow the metal rods (22) to be hooked into the holes (26) in the inner cylinder wall.

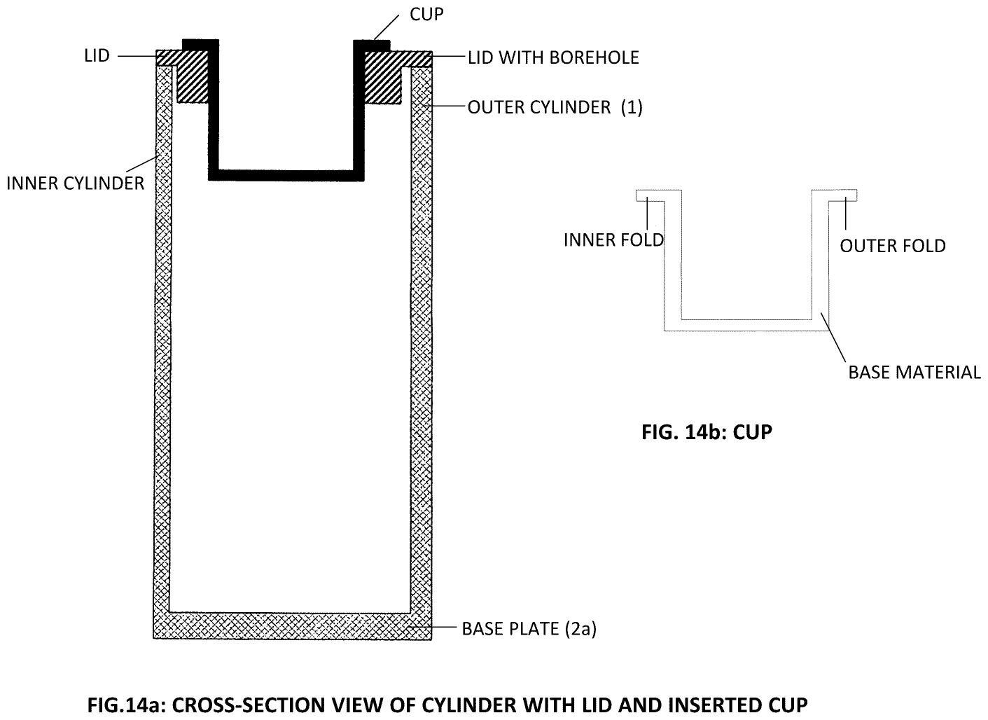

In a further version, the 4 boreholes (21) in the lid are used to insert four cups that serve as candle holders (FIG. 14). The cups (FIG. 14b) are preferably made of glass.

The cups have a diameter of 29 mm, a depth of 25 mm and a 5 mm wide outward-curved rim (FIG. 14b). In this execution, the entire hollow body can be placed standing on a surface or hung up.

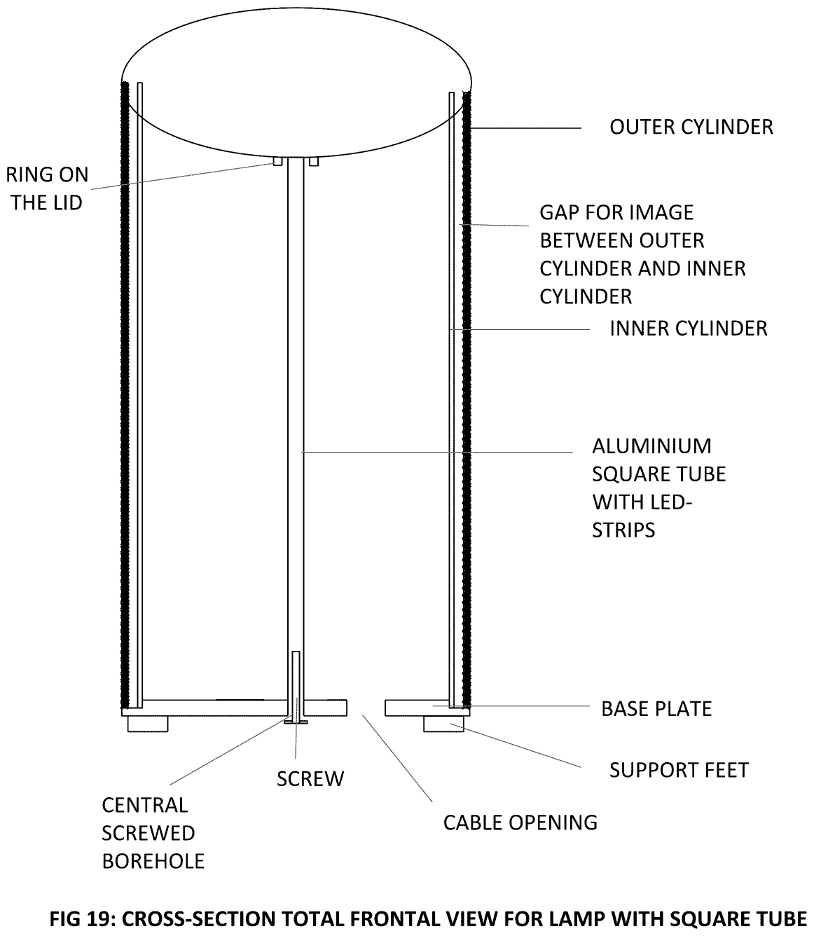

### Example 4 With LED strips as Light Source (Shown in FIG. 19)

1. On a transparent Plexiglas base with a thickness of 15 mm, an outer diameter of 220 mm and a fold diameter of 194 mm (fitting for a satin-finished inner tube), a transparent Plexiglas tube with an outer diameter of 220 mm and an inner height of 1600 mm is glued. The fold is 7 mm high and matches a satin-finished inner tube with an outer diameter of 200 mm (inner diameter 194 mm) (see drawing of the base).

2. The base has a central screw bore M8 with a countersink for a stainless steel countersunk screw M8.

3. The base has a further simple (i.e. smooth) borehole with a diameter of 35 mm at a distance of 25 mm from the outer edge of the central screw borehole.

4. Four “feet” made of transparent Plexiglas are glued to the underside (i.e., outside) of the base, each “feet” with a diameter of 40 mm and a thickness of 10 mm. The “feet” are glued close to the outer edge and equidistant from each other (see FIG. 8).

5. A satin-finished Plexiglas tube with an outer diameter of 200 mm (inner diameter 194 mm) is placed centrally in the transparent outer vessel.

6. A printed translucent film with a height of 159.7 cm and a width of 67.8 cm is inserted into the space between the outer and inner cylinder.

7. A 140 mm long M8 stainless steel screw is screwed into the central screw borehole of the base from the outside so that the screw is inside.

A 159 cm long square tube is placed on this screw. This square tube is preferably made of aluminum with an edge length of 10-12 mm. Before inserting the tube onto the screw, a 150 cm long and 10-12 mm wide commercially available LED strip is glued to each of the four sides of the square tube. This dimmable LED strip preferably has an adjustable light color from 2900 to 6000 Kelvin and comes equipped with a power cable and a remote control.

Preferably, a LED strip is chosen that that is compatible and controllable with all common smart home systems, preferably with the ZigBee wireless standard, in order to relieve the WLAN system.

A smart light strip is chosen that can be controlled via an app or via a bridge and can preferably also be operated with voice commands via Google Assistant, Amazon Alexa or Apple Siri.

The four LED strips are connected to each other at the top with cables (soldering).

The square tube is fixed at the bottom by the screw and at the top by a ring in the lid.

8. A satin-finished Plexiglas lid with a thickness of 8 mm and a diameter of 220 mm is placed on the vessel. This lid has a groove adapted to the inner tube 194 mm and fold width of 6 mm for 220 mm outside.

A ring made of transparent Plexiglas with an inner diameter of 18 mm and a height of 25 mm is glued centrally to the underside of the lid.

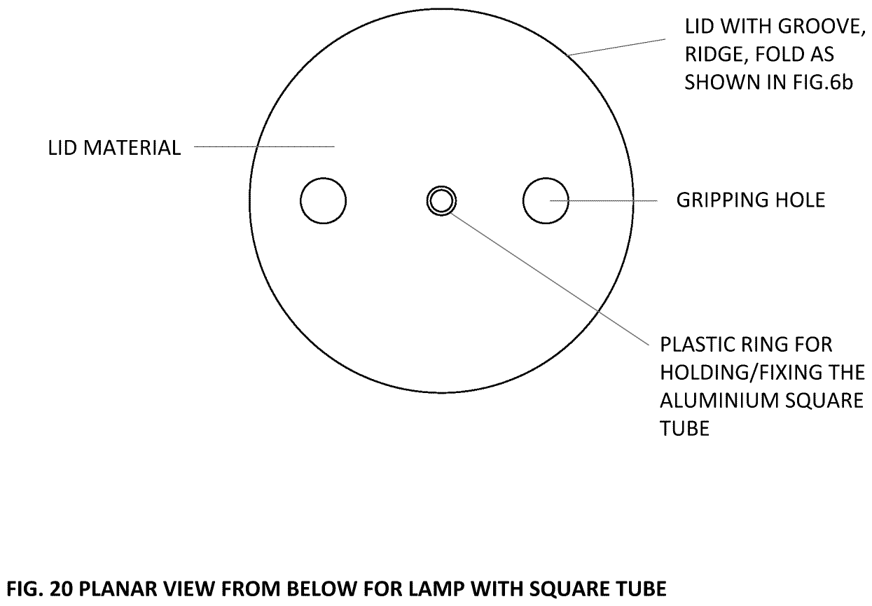

To the right and left of the ring there is a borehole with a diameter of 25 mm serving as gripping holes. The distance between the center of the ring and the center of the gripping hole is 50 mm (FIG. 20).

The distance between the individual LEDs of the adhered LED strip is equal to or less than ⅕ of the shortest horizontal distance of the LEDs to the inner cylinder. In example 4, the distance between the LED points arranged in pairs and the next LED pair is 10 to 11 mm.

The shortest distance to the inner cylinder, the diffuser, is five centimeters or more. In the described example here, the shortest distance from a single LED to the wall of the inner cylinder is 91 mm, i.e. 9.1 cm.

The individual LEDs have a beam angle of approximately 120°. Depending on the manufacturer, the beam angle varies by a few degrees. By overlapping the individual light cones and after achieving a distance of five times the individual spacing of the LEDs, a uniform 360° light source is created for the viewer. When viewed from outside, the image is evenly illuminated.

The amount of light reaching the inner cylinder is equal at every point. The only exception is the top and bottom edges of the inner cylinder. This is not visible to the viewer. Differences in brightness or shadows are no longer visible.

### LIST OF ILLUSTRATIONS

FIG. 1: Principle sketch round cylinder

FIG. 2: Principle sketch oval cylinder

FIG. 3: Example of a prismatic cylinder, here a hexagonal prism

FIG. 4: Cross-section frontal view of total first execution type according to invention—with schematic lid for perspective

FIG. 5: Cross-section frontal view of total first execution type according to invention—without lid

FIG. 6a: Central Cross-section view—execution example 1

FIG. 6b: Planar view from below of lid—execution example 1

FIG. 6c: Planar view on base/pedestal or lid from circular cylinder without light source and without socket (schematic)

FIG. 7: Planar view with a. 1 borehole, b. 2 boreholes, c. 3 boreholes

FIG. 8: Planar view of base from below—execution example 1

FIG. 9: Vertical cross-section view of pedestal—execution example 2

FIG. 10a: Cross-section view ring-shaped cylinder—execution example 3

FIG. 10b: Cross-section view lid—execution example 3

FIG. 11: Planar view cylinder without lid—execution example 3

FIG. 12: Planar view from below of ring-shaped lid—execution example 3

FIG. 13: Planar view of the suspension—execution example 3

FIG. 14a: Cross-section view of cylinder with lid and inserted cup—execution example

FIG. 14b: Cup—execution example

FIG. 15: Cross-section view of cylindrical interchangeable frame with three LED-tubes

FIG. 16: Non-planar view bayonet catch base—principle sketch

FIG. 17: Non-planar view bayonet catch with base and lid—principle sketch

FIG. 18: Cross-section view through a cylindrical interchangeable frame with internally mounted energy source

FIG. 19: Total cross-section frontal view—execution example 4

FIG. 20: Planar view of lid—execution example 4

### NUMBERING IN THE FIGURES

(1) Outer hollow body
(2a) Base plate
(2b) Pedestal
(3) Lid
(4) Light source
(5) Inner hollow body
(6) Picture
(7) Cable opening
(8) Support feet
(9) Socket
(10) Central borehole-lid
(11) Fold in lid
(12) Groove in lid
(13) Gap for picture between outer and inner hollow body
(14) Fold in pedestal for outer cylinder
(15) Groove in pedestal for inner cylinder
(16) Ridge
(17) Central borehole for socket in pedestal
(18) Groove for suspension
(19) Inner fold of lid—execution example 3
(20) Outer fold of lid—execution example 3
(21) Borehole Lid—execution example 3
(22) Metal rod for suspension
(23) Ring for suspension—execution example 3
(24) Round disk—execution example 3
(25) Hook on the round disk—execution example 3
(26) Borehole in inner cylinder for the suspension-execution example 3

1. An Illuminated cylindrical, elliptical or prismatic interchangeable frame for one or more motif-bearing translucent materials, comprising:
an elongated housing an outer hollow body and an inner hollow body, wherein the outer hollow body has translucent walls having a round, elliptical, or prismatic cross-section, the outer hollow body being closed at one end by a base plate and at an opposite end by a lid; and
one or more electric light sources within the housing, wherein, between the light source or the light sources and the motif-bearing translucent materials, the inner hollow body is open and having a round, elliptical or prismatic cross-section, wherein the inner hollow body is fixated by a circumferential groove or fold in the lid and or in the base plate, or on a pedestal, and wherein a gap is provided between the inner and outer hollow bodies for accommodating the translucent materials.

2. The frame of claim 1, wherein the gap between the inner and outer hollow bodies houses the motif-bearing translucent materials or images.

3. The frame of claim 2, wherein the motif-bearing translucent materials stand freely spaced apart in the gap, or are held in place by a groove in the base plate or lid, wherein, the lid or base plate has multiple grooves.

4. The frame of claim 1 wherein the motif-bearing translucent materials comprise translucent materials [and/] or transparent materials that are arranged one behind the other.

5. The frame of claim 1, wherein the inner hollow body are each formed out of one or more materials selected from the group consisting of glass or plastic, with a matted surface on one or both sides, satin white acrylic glass, opal acrylic glass, satin acrylic glass, satin glass, opal white glass. pearled acrylic glass and Polymethyl methacrylate (PMMA).

6. The frame of claim 1, wherein the inner hollow body comprises a light-scattering film.

7. The frame of claim 1, wherein the motif-bearing translucent materials include a fabric selected from the group consisting of: a flexible flat material, paper, parchment paper, photo paper, plastic, perforated metal foil. and fabric made of natural synthetic fibers (canvas).

8. The frame of claim 7, the motif-bearing translucent materials include a printable plastic film selected from the group consisting of PET, polyethylene terephthalate, polypropylene, and polyethylene, the plastic film being crystal clear, white-matte translucent or matte-translucent and being coated for printing.

9. The frame of claim 1, wherein the motif-bearing translucent materials each have a thickness of 50 to 500 μm, particularly preferably 75 to 250 μm, most preferably 95 to 175 μm.

10. The frame of claim 7, wherein the fabric has a surface weight of 200 to 500 grams per square meter, and particularly preferably from 280 to 380 grams per square meter.

11. The frame of claim 1, wherein the outer hollow body has a cross-sectional diameter between 11.4 cm and 105 cm, and wherein the inner hollow body has a diameter between 10 cm and 100 cm, preferably between 20 and 80 cm.

12. The frame of claim 1, wherein the base plate and the lid each have provided thereon one or more grooves for receiving and fixating the inner hollow body.

13. The frame of claim 12, wherein each groove has a preferred depth 3 mm and 80 mm and a preferred width between 51 μm and 5 mm.

14. The frame of claim 1, wherein the frame is configured for presentation of one or more of: photographs, printed products, paintings and works of art.

15. The frame of claim 14, out configured such that the presentation is accessible by removing the lid by hand.

16. The frame of claim 1, wherein the lid is configured to allow separating from the inner hollow body by means capable of being lifted or unscrewed, or by a locking mechanism.

17. The frame of claim 16, wherein the lid is configured such that the inner hollow body and the outer hollow body are separated when the lid is lifted or unscrewed.

18. The frame of claim 1, wherein the frame is configured for use any of: living spaces, galleries, museums, medical practices, clinics, law firms, hotels, cafes, representative reception rooms, exhibitions, trade shows, and in advertising for the presentation of photographs, printed products, paintings, and artworks.

19. The frame of claim 1, configured to be rotatable or to be located on a turntable so as to allow a rotation to be carried out manually or electrically via wireless or wired control.

20. The frame of claim 1, wherein the light sources provide axial lighting providing a total beam angle of 330° to 360°.

21. The frame of claim 20, wherein the light sources are powered by an electrochemical primary cell, an electrochemical secondary cell, a fuel cell, an arrangement of supercapacitors, or any combination thereof.

22. The frame of claim 1, wherein the inner hollow body is formed out of a self-supporting perfusor film.

23. The frame of claim 22 wherein the perfusor film scatters light such that or the inner cylinder, together with translucent materials, form a Lambertian radiator to an observer.

24. The frame of claim 1, wherein the inner and outer hollow bodies each have a length between 10 cm and 250 cm, preferably between 20 cm and 220 cm, and particularly preferably between 30 cm and 190 cm.

25. The frame of claim 1, wherein the inner hollow body and the outer hollow body are separated between 2 mm and 400 mm, preferably 2 mm and 200 mm, and particularly preferably between 2 mm and 50 mm,

26. The frame of claim 1, wherein the inner hollow body and the outer hollow body each have wall thickness between 2 mm and 20 mm.

27. The frame of claim 1, wherein an inner surface of the inner hollow body is lined with LED diodes.

28. The frame of claim 1, wherein the inner hollow body has a gridded surface made of polyacrylic glass (PMMA), the frame further comprising LEDs provided at an edge of the inner hollow body, at the base plate, the pedestal or at the lid.
